(19) United States
(12) Patent Application Publication
(10) Pub. No.: US 2024/0169971 A1
(43) Pub. Date: May 23, 2024

(54) CONTEXT-BASED ANNUNCIATION AND PRESENTATION OF SIGN LANGUAGE

(71) Applicant: Comcast Cable Communications, LLC, Philadelphia, PA (US)

(72) Inventors: Natalie Mazer, Philadelphia, PA (US); Arpit Mathur, Pittsburgh, PA (US); Hamed Nazari, Sunnyvale, CA (US)

(21) Appl. No.: 17/992,091

(22) Filed: Nov. 22, 2022

(51) Int. Cl. G10L 13/027; G06V 40/20; G10L 15/18; G10L 25/63

(52) U.S. Cl. CPC G10L 13/027; G06V 40/28; G10L 15/18; G10L 25/63

(57) ABSTRACT

A plurality of voice models may be available for annunciating a sign language sign. The voice models may represent different types of annunciation (e.g., happy, angry, sad, etc.), and contextual information may be used to dynamically select a voice model for annunciating a recognized sign language sign in any environment, such as a presentation or a video meeting.

### BACKGROUND

Sign language (e.g., American Sign Language, or ASL) allows users the ability to communicate using their hands. However, communicating via ASL can be rather cumbersome if one ASL signer is communicating with a voice speaker who does not understand sign language. The situation can be even worse for some forms of communication, such as video conference calls and telephonic calls, which may limit the signer's ability to fully express themselves and feel engaged in a conversation.

### SUMMARY

The following summary presents a simplified summary of certain features. The summary is not an extensive overview and is not intended to identify key or critical elements.

A computerized system may automatically recognize signs made by a signer (e.g., hand motions in ASL), and may use a voice model to translate the signs into audible words for non-signers to hear in a communication session. Multiple voice models may be available to audibly announce the same sign (e.g., speaking the same words in a more excited tone, a sad tone, a neutral tone, etc.), and various sources of context information may be used to select a voice model to annunciate the signer's sign in a contextually-appropriate voice. For example, selection of a voice model may be based on the reactions of others engaged in a video conference, reactions of others who are in the same room as the signer, metadata associated with a stream being viewed in the video conference, environmental information, as well as analysis of the signer's body (e.g., facial expressions, hand speed, etc.).

After a voice model is selected to translate the signer's sign, a translation of the signer's sign may result in audible words, corresponding to the sign, played using an audio quality that is commensurate with the context (e.g., voice tone, volume, matching mood in the room). Additional emotive images may be displayed for others to see, to further convey the proper context of the signer's words. An artificial representation of the signer (e.g., an avatar) may be animated with exaggerated emotive aspects. Different voice models may be selected on a dynamic basis while the signer is making signs, such as on a sign-by-sign basis for and/or as other dynamic factors change the mood of the conversation. These and other embellishments may be added to help convey the context (e.g., emotion, mood, etc.) of a signer's signs.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network that may be used to implement the various features described herein.

FIG. 2 shows hardware elements of a computing device that may be used to implement any of the devices described herein.

FIGS. 3-4 show example video conference user interface with context-based voice model translation of signers' signs.

FIG. 5 shows an example sign language translation system employing various features described herein.

FIGS. 6A-C show examples of an emotional valence chart that may be used to implement the features described herein.

FIG. 7 shows an example algorithm for translating sign language using various features described herein.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

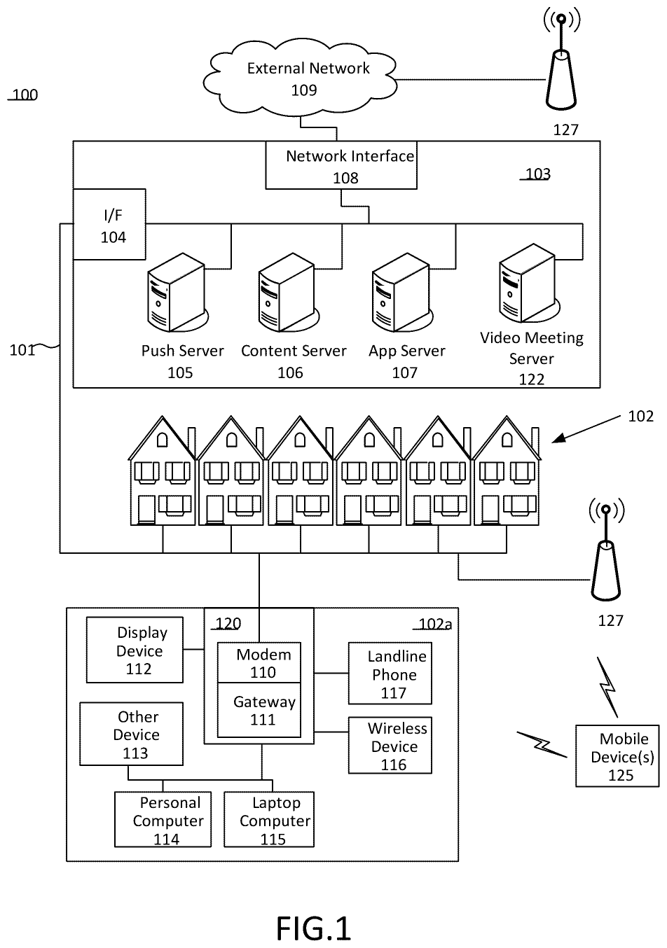

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend computing devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as a video meeting server 122 (described below), additional push, content, and/or application servers, and/or other types of servers. Although shown separately, the push server 105, the content server 106, the application server 107, the video meeting server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

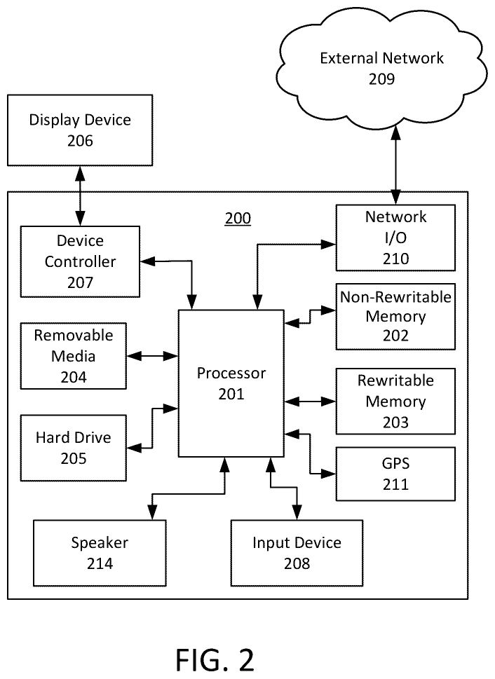

FIG. 2 shows hardware elements of a computing device 200 that may be used to implement any of the devices shown in FIG. 1 (e.g., the mobile devices 125, any of the devices shown in the premises 102a, any of the devices shown in the local office 103, any of the wireless access points 127, any devices with the external network 109) and any other devices discussed herein (e.g., cellphone, laptop, tablet, or stand-alone computer, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

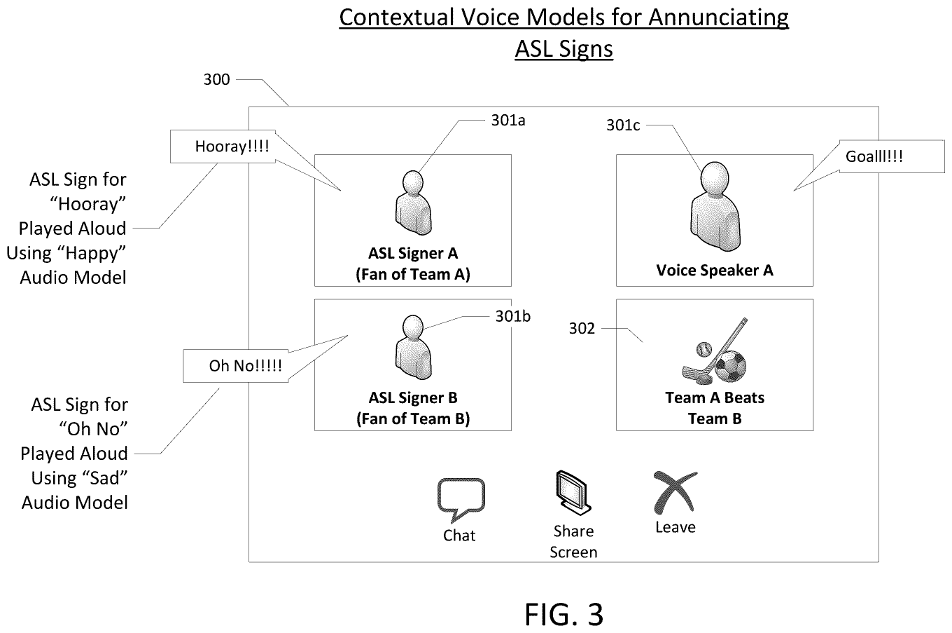

FIG. 3 shows an example screen 300 of an online video meeting (e.g., an Internet video meeting, a video conference call, etc.) being held between three participants (301a-c). The participants in this example comprise a Signer A (301a) who is using sign language (e.g., ASL) to communicate in the video meeting, a Signer B (301b) who is using sign language to communicate in the video meeting, and a voice speaker A (301c). Video of each participant (301a-c) is shown in the screen 300. In the FIG. 3 example, the participants (301a-c) are jointly watching a video stream 302 of a sporting event, such as a football game, and sharing in each others' virtual company. They may each react to events occurring in the football game. For example, Signer A (301a) may happily cheer when their preferred team is winning the football game, signing the word “Hooray” while smiling and standing. Signer B (301b), a fan of the losing team, may react sadly, by signing the words “Oh No” and looking downwards in a dejected fashion while slumping in their chair. Voice Speaker A (301c) may also be a fan of the winning team, and may cheer loudly, audibly shouting “Goal!” Although an online video meeting 300 is described as an example, the various features described herein are not limited to online video meetings, and instead may be used in any system that seeks to annunciate a signer's sign language signs into audible form for others to hear.

An example context-based sign language translation system, as described herein, may use the video images of the meeting participants, along with other contextual information, to help convey the context and emotion of the participants' reactions for other members of the meeting. Using image recognition, the system may recognize that Signer A (301a) has signed the word “Hooray,” but instead of merely playing a monotone “Hooray” for the meeting's audio output to the other participants, the system may use a different voice model that shouts the same word “Hooray” in a more joyous manner. There may be a plurality of different available voice models for different contexts, such that the same hand sign may be annunciated differently to convey the proper context. A “happy” voice model may annunciate the word “Hooray” loudly and in a happy tone, while an “angry” voice model may annunciate the same word but in a more gruff, sarcastic tone. Signer B (301b), who dejectedly signed “Oh No,” may have that hand sign annunciated using a “sad” voice model, which speaks the words in a softer, sadder tone. The selection of voice models may be dynamic, and may occur with each detected sign. Voice models may be continuously evaluated and selected based on the most recent situations. The happy Signer A (301a) may be happy in one moment because their team has won possession of a football, but then may become sad in the next moment if, for example, their team immediately loses possession of that football.

As will be explained further below, the selection of an appropriate voice model may be based on a variety of factors. Facial recognition of the signers may be used to recognize certain expressions and corresponding emotions, such as smiles for happiness, frowns for sadness and anger, etc. The speed and range of a signer's hand movements may also be used, with faster signs being associated with higher degrees of excitement and emotion, slower signs being associated with lower degrees of excitement and emotion.

The selection of a voice model may be based on contextual information, such as additional information outside of the video image of the signers. Contextual information may include a wide variety of additional types of data, such as secondary video feeds, metadata for content items being watched in the meeting, environmental information associated with the various participants in the meeting, etc. These will be discussed in more detail below.

Annunciations of sign language are discussed herein as examples, but the same contextual translation may occur in the other direction as well, in the translation of voice for a deaf participant. Voice Speaker A (301c), who happily shouted “Goal!!,” may have that audio translated to a closed-captioning feed, and may be visually punctuated (e.g., with exclamation marks) to convey the tone of that speaker's voice.

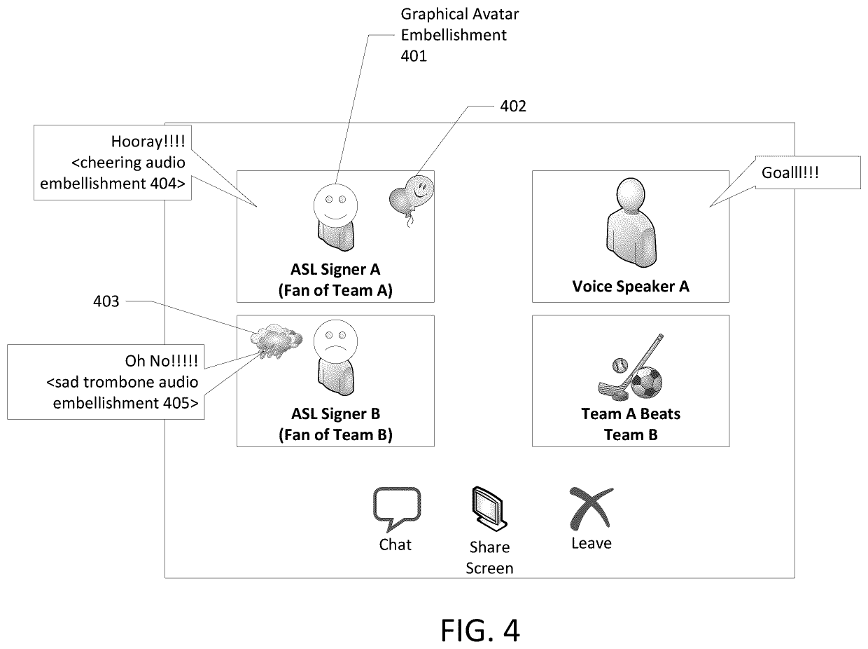

The translation of a hand sign may result in more than simply an annunciation of signed words and phrases. Various embellishments may also be used to further convey the signer's contextual meaning. FIG. 4 shows the same screen 300 from FIG. 3, but with additional embellishments. A graphical avatar embellishment 401 may be superimposed on the Signer A (301a), to illustrate that participant's happiness in a cartoonish way. Other graphical additions, such as celebratory balloons (402) or dejected clouds (403), may be added to further convey the context of what is signed.

Audio embellishments may also be added. Signer (301a)'s happy cheer of “hooray” may be embellished with the addition of an audio effect 404 of a clapping audience of cheering fans, while the sad “Oh No” of Signer B (301b) may be accompanied by audio of a sad trombone sound effect 405. Various other types of embellishments may also, or alternatively, be used, and more will be discussed further below.

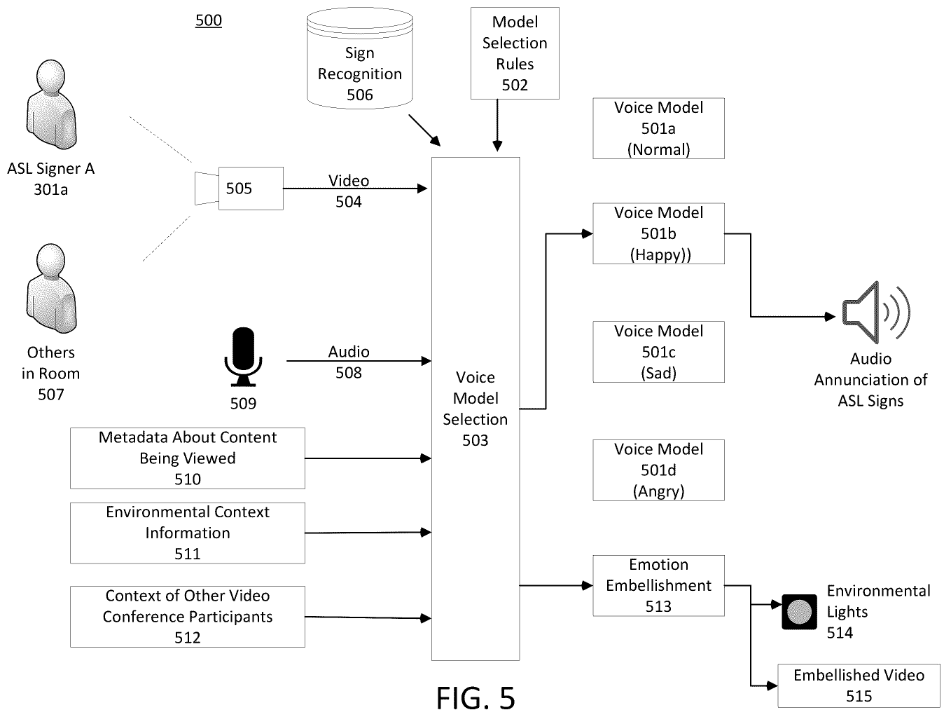

FIG. 5 illustrates an example contextual sign language translation system 500, which may be implemented using the various elements described above. Various sign language translation models 501a-d may be provided, and may be stored in any of the data storage devices described herein (e.g., in computing device 200, video meeting server 122, etc.). Each model may comprise image information indicating body movement patterns for different sign language signs (e.g., hand positions, finger positions, corresponding movements, etc.), and audio recordings of annunciations of various words and phrases corresponding to the different signs. For example, the models 501a-d may each comprise image recognition data for recognizing a hand sign for the word “hooray,” and the different models may comprise different voice recordings (whether recorded from an actual person, or simulated) of a person speaking the word “hooray.” The happy model 501b may have the voice recording of a person saying “hooray” in an upbeat tone, while the angry model 501d may have the voice recording of a person saying “hooray” in a dejected, sarcastic tone. If desired, the models 501a-d may simply comprise the voice recordings, and the image recognition data may be stored elsewhere.

One or more voice model selection rules 502 may be stored, with the voice models 501a-d and/or separately, and may contain rules for determining which voice model 501a-d to use for annunciating recognized signs. There may be separate voice model selection rules 502 for each sign that can be made, and the voice model selection rules 502 may indicate various combinations of contextual inputs that will result in selection of a voice model for a particular sign. The contextual inputs may come from a variety of sources, and may be processed by a model selection process 503 executing on, for example, video meeting server 122, personal computer 114, or any other device described herein.

Contextual inputs may be based on processing video 504 of the signer and/or others, from one or more cameras 505. The voice model selection 503 may receive a video image of the signer and detect positions and/or movements of a signer's hands, arms, body, face, etc. (e.g., a first camera may capture a head and shoulder view of a signer 301a for display in a meeting window 300, while another camera may capture a view focused on the signer's 301a torso and hands for easier recognition of sign language signs) and identify a matching sign in a sign recognition database 506 (which may contain image recognition data for recognizing various signs in a video image) to determine a sign being made, and may also determine a voice model based on the video 504. For example, the voice model selection rules 502 may indicate that if the sign for “hooray” is made at a slow pace, then the sad voice model 501c may be contextually appropriate. The voice model selection rules 502 may indicate that if the signer's face is recognized as having a smile, then the happy voice model 501b may be contextually appropriate. Images of others 507 in the same room may also be used to select a contextually appropriate voice model. Of course, different contextual inputs may provide conflicting suggestions (e.g., a smiling face but a slow hand movement), so the voice model selection 503 may combine various contextual inputs before making an actual selection of a voice model.

Contextual inputs may be based on processing audio 507 of the signer and/or others, from microphone 509. For example, a loud sound of one hand striking another while making a sign may suggest that a more excited voice model, such as the happy voice model 501b or angry voice model 501d, may be contextually appropriate. Recognized cheering from others 507 may suggest that the happy voice model 501b should be used.

Contextual inputs may be based on metadata 510 that accompanies a content item, such as a football game 302 being viewed in a video meeting. The metadata 510 may, for example, be contained in a synchronized data stream accompanying the football game 302, and may contain codes indicating events occurring in the football game 302, such as a touchdown being scored by Team A at the 5:02 point in the first quarter. The voice model selection 503 may determine that such an event is an exciting one, and this may suggest that the happy voice model 501b or angry voice model 501d should be used. The voice model selection 503 may use a user profile associated with the signer 301a to assist with interpreting the context. For example, if the user profile indicates that Signer A 301a is a fan of Team A, then the touchdown scored by Team A may be suggestive of a happy mood, and suggestive of selection of the happy voice model 501b. Conversely, if the user profile indicates that Signer A 301a is a fan of Team B, then the touchdown scored by Team A may be suggestive of a sad or angry mood, and selection of a corresponding sad voice model 501c or angry voice model 501d. The user profile may be stored at any desired location, such as the voice meeting server 122, personal computer 114, or any other desired device. The user profile may contain any desired preference of the users. For example, a profile for Signer A 301a may indicate that Signer A 301a prefers to use a more subdued voice model for annunciating their signs, or to use a voice model having a particular accent, gender speaker, etc.

Contextual inputs may be received as environmental context information 511, which may include any desired information from an environment associated with the signer 301a. For example, the temperature of the room, the operational status of devices such as a home security system, the processing capacity of a computer 114, and/or any other environmental conditions may be used to assist in selecting a voice model. Environmental context information 511 may include status information from other devices, such as a set-top box, gateway 111, display 112. For example, environmental context information 511 may include information indicating a current program status of a content item being output by a display device 112. Environmental context information 511 may include information regarding any sort of environment. Data traffic on a social media network may be monitored, and changes in such traffic (e.g., if suddenly a lot of users send messages saying “goal!!!”) may be reported and used to assist in selecting a voice model.

Contextual inputs may be received as context information 512 of other participants in the video conference, such as Signer B 301b and Voice Speaker 301c. This context information 512 may include the same kinds of contextual information (e.g., video, audio, metadata, environmental, etc.) as discussed above, but may be associated with other users besides the Signer A 301a whose sign is being annunciated. For example, if the general mood of the others (Voice Speaker A 301c, Signer B 301b) is a happy one, then that contextual information 512 may suggest the happy voice model 501b should be used to annunciate signs made by Signer A 301a.

After a voice model is selected, additional embellishments 513 may also be used to accentuate the annunciation of Signer A 301a's sign. For example, environmental lighting 514 may be controlled to flash different colors according to the signer's mood (e.g., red for angry), video embellishments 515 may be added to the video interface 300 (e.g., balloons 402), audio embellishments may be added (e.g., sad trombone 405), and/or other embellishments as desired. An audio embellishment may alter the playback of a voice annunciation. For example, if the word “Goal” is to be annunciated in a happy tone, and is the result of a soccer goal being scored by a signer's 301a favorite team, then the voice model selection rules 502 may call for an audio embellishment to elongate the annunciation of the word “Goal”—resulting in “Gooooaaaaalllll!!!” commensurate with a celebratory mood. The embellishments may include controlling other devices in the environment. For example, some embellishments may call for adjusting lighting in the room (e.g., dimming lights, changing color themed lights), adjusting audio volume, etc.

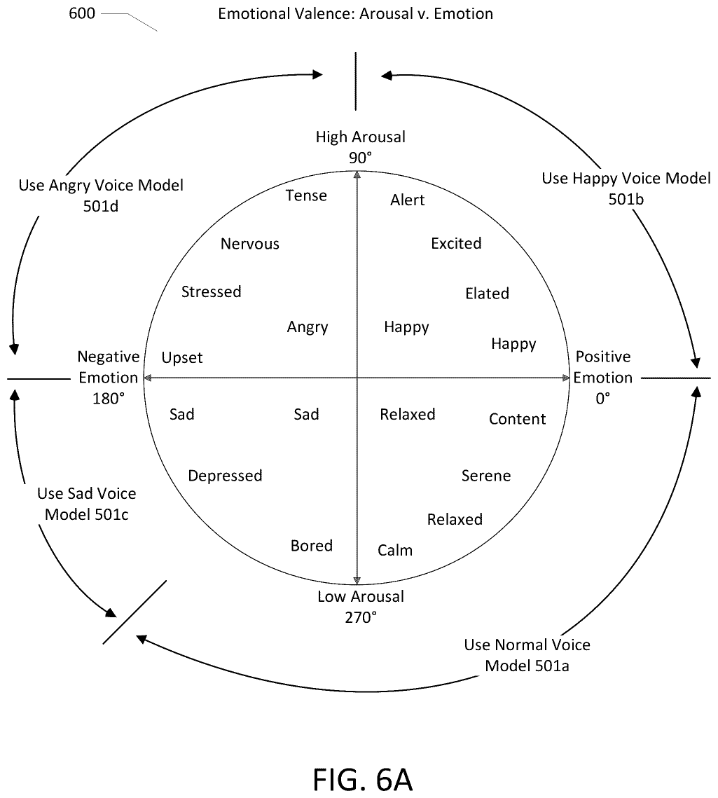

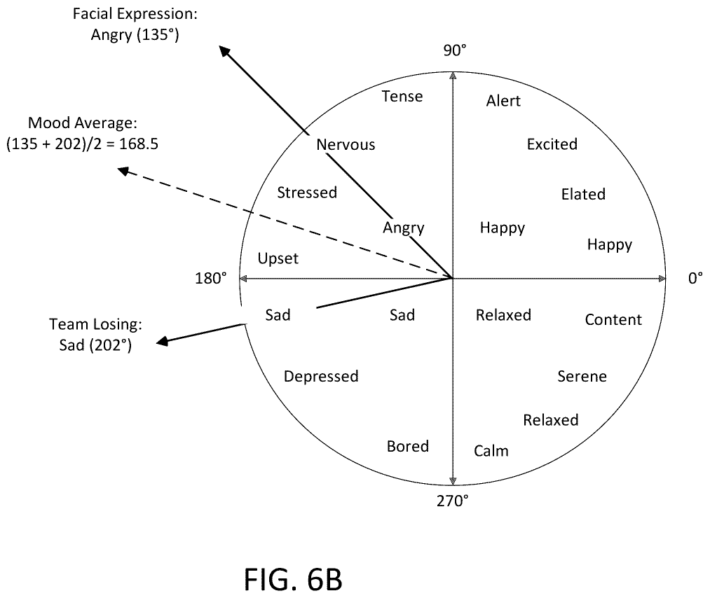

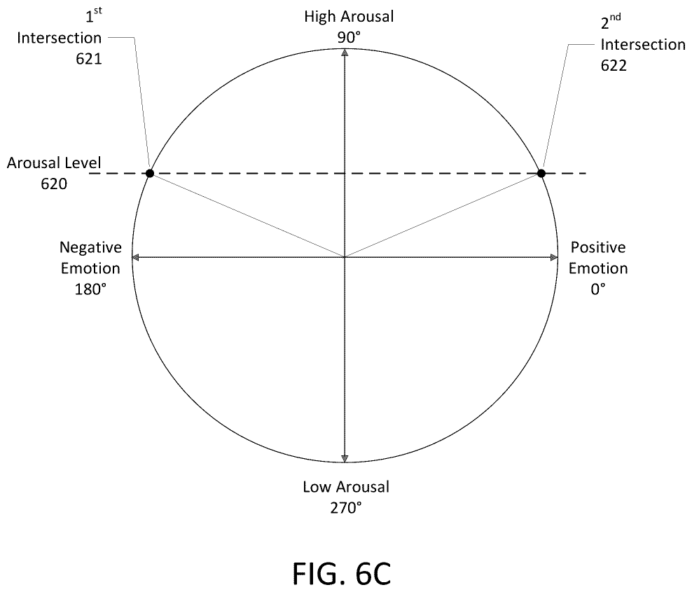

As discussed above, various contextual inputs may contribute to the selection of a voice model. FIGS. 6A and B illustrate an example emotional valence circle 600, which may show how different emotional states may relate to one another, and how the contextual inputs may be combined for the selection of the voice model. The different voice models may be mapped to different areas of the emotional valence circle 600, and different contextual inputs may contribute to an overall final value. For example, the happy voice model 501b may be mapped to an arc from 0° to 90° on the circle 600. The angry voice model 501d may be mapped to an arc from 91° to 180° on the circle 600. The sad voice model 501c may be mapped to an arc from 181° to 250° on the circle 600. The normal voice model 501a may be mapped to an arc from 251° to 359° on the circle 600. An angular value may be used to represent the current contextual mood, and the corresponding voice model may be selected, and various contextual inputs may provide inputs to that angular value. In the example illustrated in FIG. 6B, a voice model selection process 503 may determine that a signer's face appears to be making an angry expression (via processing of video 504), and that the metadata 510 indicates that the signer's favorite team is losing the game 302 that is being watched. The facial expression contextual input may be assigned an angular value of 135° (centered in the “Angry” quadrant), and the metadata contextual input may be assigned an angular value of 202°. An overall mood for the signer, based on those example contexts, may be an average of the angular values (135°+202°)/2=168.5°. Using the example FIG. 6A mapping, such an angular value would result in selection of the angry voice model 501d (since 168.5° is between 91° and 180°). The FIG. 6A example only uses two contextual inputs for simplicity, but any quantity of contextual inputs may be used. The various inputs may also be weighted differently. For example, if the facial recognition process returns a low degree of confidence in recognizing the angry expression, but the metadata processing has a high degree of confidence that the signer's team is losing, then the voice model selection process 503 may simply disregard the facial recognition context, or otherwise reduce the influence of the facial recognition context on the overall angular value.

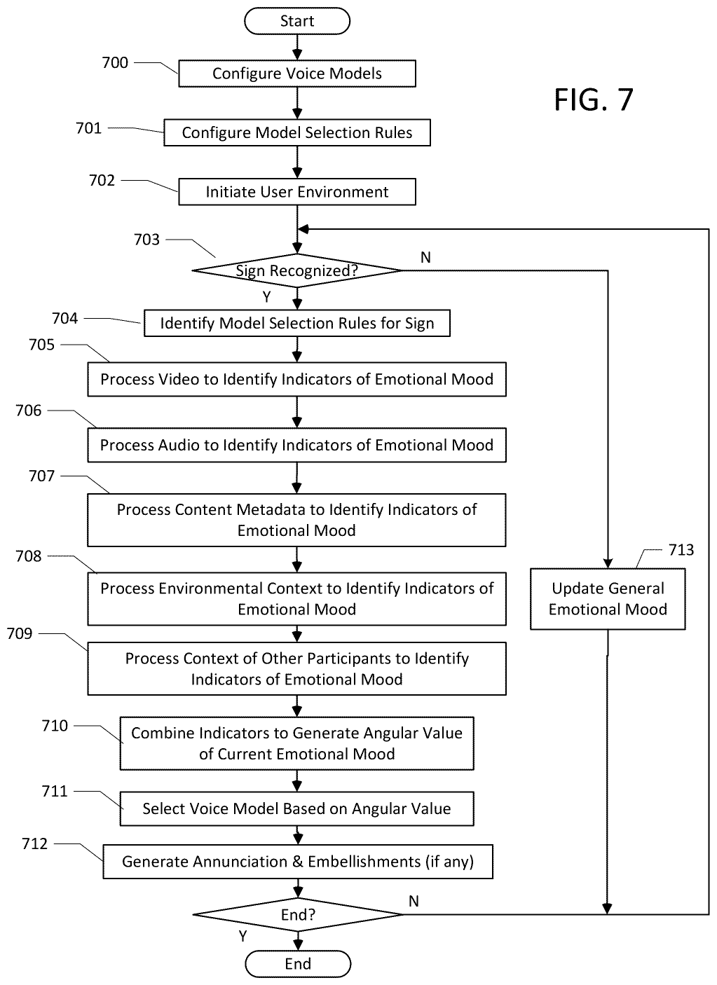

FIG. 7 illustrates an example process for contextual sign language communication. The process may be performed by any one or more computing devices (e.g., video meeting server 122, personal computer 114) to carry out the voice model selection 503 and processing features described herein. For example, each participant in the meeting 300 may have their own computing device 114, and each of their devices may perform this process for annunciating signs made by other participants. Alternatively and/or additionally, some of the steps may be performed centrally, such as by video meeting server 122, for improved efficiency.

At step 700, the various voice models 501a-d may be initially configured. This initial configuration may entail generating audio annunciations of a person speaking different words using different emotions, such as speaking the word “Hooray” in normal, happy, sad, and angry tones. The annunications may be generated by recording a person speaking the word in those different tones, by using speech synthesis to simulate a person speaking the word in those different tones, and/or by any other desired speech technique.

The initial configuration of voice models 501a-d may also comprise associating each audio annunciation with corresponding image information for a corresponding sign language translation of the word. For example, the ASL sign for the word “hooray” involves the signer making fists with both hands and raising them both in front of their body. The image information for that sign may include video images of a signer making the same gesture with their hands. The image information may include information identifying the gesture in other ways, such as vectors, identifying the hand shapes and movements involved in signing that word. The image information and corresponding audio annunciations may be stored as the various voice models 501a-d on any desired storage device (e.g., any computing device performing and/or supporting the voice model selection process 503).

In step 701, voice model selection rules 502 may be configured. This configuration may include generating information indicating conditions under which different voice models 501a-d will be selected for annunciating a particular hand sign. For example, the configuration may generate information assigning the models to different emotional valence angular ranges, as discussed above for FIG. 6A:

| Emotional Valence Range | Use This Voice Model for “Hooray” |
|---|---|
| 0-90° | Happy Voice 501b |
| 91-180° | Angry Voice 501d |
| 181-250° | Sad Voice 501c |
| 251-359° | Normal Voice 501a |

The configuration of the voice model selection rules 502 may also generate rules indicating how different contextual inputs should be used when selecting a voice model. Various aspects of video (e.g., video 504) may be mapped to different angular values of the emotional valence 600. For facial expression contextual inputs, the voice model selection rules 502 may map different facial expressions with different angular positions on the emotional valence 600. A broad smile may be mapped to 45°, centered in the “Happy” quadrant of the emotional valence 600. A crying expression with tears may be mapped to 180°.

For signing speed contextual inputs, the voice model selection rules 502 may indicate that larger, faster hand and/or arm movements may be mapped to higher arousal states in the emotional valence 600, while smaller slower hand and/or arm movements may be mapped to lower arousal states. The voice model selection rules 502 may indicate that while the size and/or speed of the movements may be useful in determining a position on the Y-axis in the emotional valence 600 (i.e., the state of arousal), the voice model selection rules 502 may indicate that the size and/or speed of the movements are only indicative of one of the axes in the valence 600, and such single-axis contexts may still be useful in selecting a voice model. For example, FIG. 6C shows an arousal level 620, which the voice model selection rules 502 may associate with a particular hand speed movement of the signer. The signing speed may indicate a general degree of arousal, but might not indicate whether the emotional mood is positive or negative (e.g., signing fast due to excited joy, or signing fast due to anger). FIG. 6C shows that this arousal level 620 may intersect the emotional valence 600 at two points 621, 622, so the voice model selection rules 502 may associate that arousal level 620 with the angular values of both of those points 621, 622. Such single-axis contexts may still be mapped to angular values, and other contextual inputs may be used to resolve ambiguities (e.g., whether the high arousal was positive or negative).

The signed word(s) may be contextual inputs, and the voice model selection rules 502 may map different words to different angular values on the valence 600. For example, the word “hooray” may be mapped to an excited emotion and angular value on the valence 600, while curse words may be mapped to stressed or upset angular values on the valence 600.

The voice model selection rules 502 may map different audio characteristics (e.g., sounds in audio 508) to different angular values in the emotional valence 600. Sounds of cheering or clapping hands may be mapped to a very excited and happy angular value, such as 45°. Sounds of cheering alone, without clapping of hands, may be mapped to a slightly less excited, but still happy, angular value, such as 20°. Higher volumes of audio may be mapped to higher degrees of arousal on the Y-axis of the emotional valence 600, so louder cheering may result in an angular value that is closer to 90° than the angular value of quieter cheering. Volume level may be a single-axis context, such that the volume level may indicate a position on the Y-axis (corresponding to arousal state), which may indicate two possible positions on the emotional valence 600 circle. Audio words may also be mapped to different angular values on the emotional valence 600.

The voice model selection rules 502 may map different types of content metadata (e.g. metadata 510) to different angular values of the emotional valence 600. Content metadata may comprise data (either separate from a content stream, or integrated with the content stream) that indicates events or characteristics of the content. There may be many types of content metadata. For sporting events, metadata may indicate dynamic characteristics of the sporting event, such as when a team scores points, when a player reaches a milestone, the time remaining in a game, the current score of the game, etc. The voice model selection rules 502 may map different metadata to different angular values. For example, the voice model selection rules 502 may indicate that if any team scores a goal, then that may cause a corresponding increase in arousal state for a limited amount of time after the goal (e.g., for 30 seconds after a touchdown in football). The voice model selection rules 502 may indicate that the increase is of a positive emotion if a user profile indicates that the signer is a fan of the team that scored the goal (and conversely, the increase can be a negative emotion if the signer is a fan of the opposing team in the sporting event). The user profile may be additional data that will be accessed when the rules are used, as will be discussed further below. Different kinds of scoring events may be mapped to different angular values. For example, a touchdown in football scores six (6) points, and may correspond to an angular value of 45° (elated emotional valence), while a field goal that scores only three (3) points may correspond to an angular value of 25° (happy emotional valence, but with less arousal than the touchdown).

The voice model selection rules 502 may gradually increase arousal states if opposing teams are closely matched and are playing a competitive game with both teams scoring nearly equal points, and as the game progresses towards a conclusion. For example, the voice model selection rules 502 may indicate that if the score difference between the teams is less than 5, then the arousal state may increase to a high arousal state in the final minute of the game. The voice model selection rules 502 may decrease arousal state if a game becomes less competitive, such as one team having a lead over the other team by a threshold amount (e.g., if a team has 21 points more than the opponent, then the arousal state may be indicated to be on the lower end of the Y-axis scale, as the game has become boring to watch).

The content metadata is not limited to sporting events. Content metadata may indicate when certain emotions are conveyed in other content types, such as a happy ending to a movie, a tense scene in a television program, a moment of sadness in a music video, etc., and the rules may map that metadata to corresponding angular values in the emotional valence 600. Advertisers in particular may take advantage of this, by providing metadata that punctuates their advertising messages (e.g., metadata indicates a serene value of 315° to accompany an advertisement for a mattress, to indicate how peacefully a customer sleeps with that mattress; metadata indicates an excited value of 75° to accompany a part of an advertisement in which someone receives a gift of an automobile; etc.).

The voice model selection rules 502 may map different types of environmental context information (e.g., environmental context information 511) to different angular values in the emotional valence 600. For example, if the temperature in the signer's room is above a threshold temperature, then the arousal state may be raised. If the signer's home security system is armed, then the arousal state may be raised. If the signer's profile may indicate that if it is after 9 pm (e.g., perhaps the signer's child is sleeping), then the arousal state may be lowered to try and keep reactions calmer.

The voice model selection rules 502 may indicate how context information from other participants (e.g., context of other participant 512) will affect the emotional valence 600. For example, the emotional state of other users may be averaged, and may create a suggestion for an angular value for a signer. If other users in a viewing session are at an elevated emotional state (e.g., they are all in the “Elated” range), then that could also serve to suggest a similar angular value for a signer, so that the signer's annunciations are in a tone that matches the excitement level of the others in the viewing session.

The voice model selection rules 502 may also indicate how different types of context information should be used in combination with others. The voice model selection rules 502 may indicate that angular values suggested by various contextual inputs should simply be averaged to arrive at a final angular value for the selection of the voice model. The voice model selection rules 502 may indicate that some contextual inputs should be weighted more heavily than others. For example, if a facial recognition process detects a signer's smile with a high degree of certainty, then the context suggested by the facial recognition may be weighted highly, while other contexts may be weighted lower. This may be useful if different contextual information suggest different emotions. For example, the phrase “I want to cry” might normally be mapped to a sad emotion, perhaps angle 190° in the emotional valence 600, but if the signer signed that phrase with a broad happy smile on their face, then the voice model selection rules 502 may indicate that in that situation, the signer likely was not truly feeling sadness, but was rather signing that phrase in a joking manner. So rather than suggest the sad voice model 501c, the voice model selection rules 502 may indicate selection of the happy voice model 501b.

The voice model selection rules 502 may also indicate sign(s) to which they apply (and/or to which sign(s) they do not apply), as some rules may be applicable to only a subset of possible signs. For example, the system may be configured such that a facial recognition rule that calls for elevating excitement based on detecting a smile on the signer's face is deemed inapplicable to the annunciation of the word “genocide.”

The above are merely examples of how different kinds of contextual inputs may be mapped to angular values in the emotional valence 600, and the configuration 701 of the model selection rules 502 may take into account any desired combination of the above, as well as any additional desired contexts.

In step 702, a user environment, in which sign language annunciation is desired, may be initiated. This may occur, for example, if a user joins an online meeting 300, begins to view a video feed containing a signer's hand signs, a sign language interpreter begins to make hand signs in an in-person or online presentation (e.g., video of the signer may be captured by one or more cameras, and may be processed by a computing device to recognize hand signs), or in any other type of desired user environment. The initiation 702 of the user environment may involve loading the various voice models and/or voice selection rules 502 onto any computing devices (e.g., meeting server 122, meeting participant computing device 114, etc.) that will be annunciating (whether by audio or with video embellishments) signs made by other participants in the meeting. This initiation 702 may also include the creation of the user profiles themselves. Each user may configure their own user profile by providing their preference information for storage on any computing device that will be supporting the sign annunciation features described herein. The user may specify their favorite teams, their preferred emotional reactions to various types of contextual inputs (e.g., they prefer an exaggerated sense of tension if they are viewing a movie whose metadata identifies it as a “thriller” or “suspenseful” movie), their preferred types of embellishments when annunciating their own signs and/or the signs of others (e.g., sad trombone sound and balloons graphic to embellish signs with emotional valences having the “sad” or “depressed” angular values), signs that they prefer always be annunciated in a particular emotion (e.g., always use the angry voice model if I sign the phrase “my mortal enemy”), context conditions that will always result in using a particular specified emotional valence or having a valence adjustment (e.g., during the holiday season between Thanksgiving and New Years Day, always increase the positive emotion of my signs), etc.

After the user environment is initiated, the process may begin a loop to detect whether any signs are recognized in the video 504. If a sign is detected, then in step 704, the process may consult the voice model selection rules 502 that are relevant to the detected sign, and begin a process of evaluating contextual information for selecting a voice model. As noted above, this voice model selection may be performed dynamically, and may occur as each sign is detected and/or based on changing context. A signer may sign a single sentence with a sequence of multiple words, and different voice models may be selected for each of the words in the sequence. The different voice models may comprise different audio annunciations of the same sign (e.g., the same word), and dynamically selecting different voice models for different words in the sequence may allow for a more meaningful expression of the signer's intent if, for example, the signer changes from happy to sad in the same sentence.

In steps 705-709, the various available contextual inputs may be processed to determine whether the contextual inputs are suggestive of any particular emotional mood, which may be represented by the angular value on the emotional valence 600 as discussed above. Of course, if the voice model selection rules 502 for a particular recognized sign does not need any of these contextual inputs, then some or all of the unneeded steps may be omitted. Similarly, other types of contextual inputs may be processed.

In step 705, the video 504 may be processed to identify the presence of any emotional mood indicators. As discussed above, facial recognition may be used to recognize an expression on the face of a signer 301a, and any recognized expression may be mapped, by the voice model selection rules 502, to an angular value on the emotional valence 600. The facial recognition process may also return an indicator of the confidence with which the expression was recognized, and this confidence may result in applying a weight to the angular value, as will be discussed further below in step 710. The facial recognition may recognize expressions on the faces of others 507 who are also in the room with the signer 301a, and those expressions may also be used to determine an emotional mood for annunciating the signer 301a's signs.

The video 504 may also, or alternatively, be processed to determine a size and/or speed of the sign made by the signer 301a. If the signer 301a uses large, sweeping motions when making a sign, and/or makes the sign at a very rapid pace, then that size and/or speed may be mapped to a higher state of arousal, resulting in a larger value on the Y-axis of the emotional valence 600. Smaller motions and slower signs may be mapped to lower arousal values on the Y-axis. The units on the X- and Y-axes in the FIG. 6A example may be any desired value for scale (e.g., −1.00 for low arousal, and +1.00 for high arousal).

In step 706, the audio 508 may be processed to identify one or more audio indicators of an emotional mood associated with the signer 301a. As discussed above, different recognizable sounds may be mapped to particular angular values on the emotional valence 600. For example, if the signer 301a (or anyone else in the audio 508) is heard to be sobbing, then the recognition of that sound may be mapped to an angular value for sadness (e.g., 190°), or if the signer 301a (or anyone else in the audio 508) is heard to be laughing or cheering, then the recognition of that sound may be mapped to an angular value for happiness (e.g., 20°) and/or excitement (e.g., 80°), respectively. As noted above, the audio indicators need not derive from audio originating from the signer 301a. Sounds from others in the room 507, and/or any other noises in the audio 508, may be mapped to corresponding angular values on the emotional valence 600.

In step 707, content metadata 510 may be processed to identify one or more content metadata indicators of an emotional mood associated with the content item 302 being viewed by the group. The content metadata 510 may be a data stream indicating events occurring in the content item 302. As discussed above, this may include indicating scoring in a sporting event, time remaining, player statistics, team statistics, and/or any other attribute of the content item 302. The content metadata 510 may indicate times, within the content item 302, corresponding to the attribute (e.g., a touchdown was scored with ten minutes remaining in the first quarter of a football game). The voice model selection rules 502 may indicate that the general mood of the video meeting 300 should be elevated as the sporting event nears its conclusion and if the scores of the teams are within a threshold amount (e.g., soccer game in which the score is tied and the game is in the final 5 minutes of regulation, or has entered extra time).

The content metadata 510 may be sent as a file separate from files containing audio and video for the content 302. The content metadata 510 may be transmitted as a synchronized stream, with different control codes indicating different events (e.g., the storing of a goal) at the corresponding times in the event. The content metadata 510 may be embedded in the content stream 302 itself. The content metadata 510 may be a separate file downloaded in advance of the meeting 300, and may include a timeline of events in the content item 302. As noted above, content 302 is illustrated as a sporting event, but any type of content may be used (e.g., movies, advertisements, podcasts, music, etc.), and content metadata 510 may indicate any desired mood that a creator of the content wishes to suggest for their consumers.

As noted above, user profile information may be stored for the signer 301a (e.g., on a computing device 114 being used by the signer 301a for the online meeting 300), and may be used in combination with the content metadata 510, such that the same event in the content metadata 510 (e.g., a score by Team A) may be mapped differently for different users based on their profiles. If a user's profile indicates that the user is a fan of a team scoring a point, then the scoring event may be mapped to a positive emotion. Similarly, if a user's profile indicates that the user is a fan of the opposing team who surrendered the point, then the scoring event may be mapped to a negative emotion. The content metadata 510 may indicate how different user profile characteristics should be used to map the content events to an angular value in the emotional valence 600. For example, the content metadata 510 may indicate that one event should be a 45° (excited/elated) for users who are fans of Team A, while the event should be a 200° (sad) for users who are fans of Team B.

In step 708, environmental context information 511 may be processed to identify one or more environmental indicators of an emotional mood associated with annunciating the signer's 301a sign. For example, the voice model selection rules 502 may indicate that if the ambient temperature in the signer's 301a room (e.g., as reported in data received from a thermostat device in the premises 102a) is above 78° Fahrenheit, then the arousal state for the emotional valence 600 should be elevated. The voice model selection rules 502 may indicate that if the lighting in the signer's 301a room (e.g., as reported in data received from camera 505 or another light sensor in the premises 102a) is dark, then the arousal state should be reduced. The environmental context 511 may report these environmental conditions for locations of the other participants who did not make the sign being annunciated (e.g., Voice Speaker A 301c), and these environmental conditions may be used to determine the manner in which a signer's 301a sign should be annunciated at the locations of the other participants. Different environmental conditions may result in different treatment at the different locations. For example, signer 301a may sign “hooray,” and a Happy Voice Model 501b may normally be selected for annunciating that sign. However, if Voice Speaker A 301c is sitting quietly in the dark in their home, then the annunciation of that sign may be made using a lower audio volume and/or using a less aroused voice model, in view of the more subdued mood at the Voice Speaker A's 301c location. Perhaps the Voice Speaker A 301c has turned down the lights because it is late at night and others are sleeping in the house.

In step 709, context information 512 from other participants may be used to determine one or more mood indicators. For example, if others in the meeting (e.g., Voice Speaker A 301c and ASL Signer B 301b) are seen in their videos 504 with beaming smiles on their faces, then this happiness may indicate a higher degree of happiness in the mood of the meeting 300, and as a result, may indicate a higher happiness angular value for the valence 600. The voice model selection rules 502 may indicate that facial expressions of others should be mapped to an angular value in the emotional valence 600. Any of the contextual information discussed above may be used from the perspective of the other participants in the meeting, and the voice model selection rules 502 may indicate how such contextual information of others 512 should be used.

In step 710, the various emotional mood indicators may be combined as specified in the model selection rules 502. For example, the voice model selection rules 502 may indicate that the various angular values should simply be averaged to arrive at a final angular value representing the overall emotional mood for the recognized sign. The voice model selection rules 502 may indicate that some indicators should be given priority over other indicators. For example, the voice model selection rules 502 may indicate that facial expressions recognized in the video 504 should have top priority, and that other indicators should only be used if no facial expressions are recognized in the video 504. Alternatively or additionally, the voice model selection rules 502 may indicate that some indicators should be given a reduced weight as compared to other indicators. A multi-input, multi-layer deep neural network may be used to combine the various emotional mood indicators.

The combination 710 of the angular values from the various indicators may result in a final overall angular value for the emotional mood associated with the recognized sign. Using the FIG. 6B example, a final angular value of 168.5° may result from combining emotional mood indicators from the facial recognition of video 504 (e.g., indicating that Signer A 301a had an angry facial expression when making the recognized sign) and the content metadata 510 (e.g., indicating the Signer A's 301a team is losing). In step 711, this final emotional angular value may then be used to select a voice model for annunciating the recognized sign. Using the example mapping in FIG. 6A, the final angular value of 168.5° would map to the Angry Voice Model 501d. Accordingly, the Angry Voice Model 501d may be selected for annunciating the recognized sign.

In step 712, the annunciation may be generated along with any desired embellishments. The annunciation may simply comprise playing audio of a recording of an angry person saying the word “Hooray” (if that was the sign recognized in step 703). Additional embellishments may be as described above with respect to FIG. 4. Additional sound effects (e.g., sad trombone sound) may be added. Graphical embellishments may be added. For example, an animation of clouds 403 may be used to embellish the sad signing of the word “Hooray.” Computer-generated avatars may be used to represent the signer 301a (e.g., who may select a desired avatar to represent themselves in the meeting 300), and an avatar embellishment 401 may cause output, in the video meeting 300, of a computer-generated cartoon image of an angry person shouting “Hooray” in an angry, sarcastic manner. The recognized sign(s) may also be translated to text, to create a textual transcript of the hand signs. The textual transcript may be stored in any of the storage devices described herein, and may be delivered for use along with the audio annunciations of the recognized signs. For example, a closed-caption text feed may be displayed while the audio annunciation is made.

The final emotional angular value may also be retained in memory as an indicator of a general mood in the overall meeting 300, and may be used as an additional indicator input for a future recognized sign. For example, in the combining 710, the currently-received contextual inputs (e.g., from video 504, audio 508, content metadata 510, environmental context 511, etc.) may be combined with an emotional indicator that was previously determined (e.g., the last time a sign was recognized). Maintaining an indicator of a general emotional mood may help with properly identifying the context of a subsequent signed word or phrase, as the mood of a conversation generally does not change suddenly.

After outputting the annunciation and any desired embellishments, the process may determine whether it should end (e.g., if participants leave or end the meeting, or otherwise signal a desire to turn off the voice model process), and if the process is not ended, it may return to step 703 to look for another sign. If no signs are recognized in step 703, the process may proceed to step 713. In step 713, some or all of the emotional mood indicator processing discussed above (e.g., steps 705-710) may be repeated using current emotional mood indicators, but instead of using a final emotional mood indicator to select a voice model for annunciating a recognized sign, the final emotional mood indicator may be used to update a current angular value of the general emotional mood in the meeting 300, for use in a future recognized sign as discussed above. For example, even if no sign is recognized in step 703, the voice model selection process 503 may recognize angry expressions on the faces of the meeting participants, and may determine that the current emotional mood in the meeting has become sad or angry. Perhaps the participants have all become upset at an event unfolding in the sporting event 302, but none has made a sign yet. This change in the emotional mood of the meeting 300 may then be taken into account in handling future recognized signs, as discussed above.

The examples discussed above are merely examples, and variations may be made as desired. For example, the examples above use angular values and a circular representation of the emotional valence 600, but these are not required, and any alternative approach may be used to represent the emotional valence 600 and the emotional mood indicators of the various contextual inputs.

As another example, the signer 301a may enter a command to choose a particular voice model. For example, the signer 301a may press a button on their computing device to indicate that their signs should be annunciated using the Happy Voice Model 501b. If the signer 301a selects a voice model, then that selection may be transmitted to the other participants in the meeting 300, and may be used to select the voice model for annunciating the signer's 301a signs. This selection may override one or more other emotional mood indicators as discussed above. This may be indicated using any desired input. For example, a user may define a predefined body pose and/or hand gesture to indicate a particular mood, and may use that body pose and/or hand gesture to indicate the mood. Signer 301a may indicate, in their user profile, that standing up with arms raised over their head, and fingers in a predefined configuration, indicates a selection of the Happy Voice Model 501b for annunciation of signs made within a time period of making the predefined configuration. New body positions and/or hand signs may be created to select different voice models. The new body positions and/or hand signs may be used to select embellishments. For example, the signer 301a may indicate that an annunciation of a signed word should be elongated for as long as the signer 301a maintains a predefined body position (e.g., the annunciation of the word “Goal!!” may be maintained, and elongated, as long as the signer 301a is standing with their arms outstretched in a predefined position). The final position of an existing sign language sign may be maintained by the signer 301a, and the annunciation of that word may automatically be extended to continue annunciating the signed word (e.g., repeating the word, stretching out the word's final vowel or syllable, etc.).

The emotional mood of the meeting 300, as discussed above, may be used to select a voice model for annunciating words that are signed, and the process can also operate in the other direction, with the emotional mood being used to select a visual annunciation of spoken words. For example, Voice Speaker A 301c may shout “Goall”, and the voice model selection rules 502 may indicate that the facial expression and audio excitement level warrant use of graphical embellishments to help the Signer A 301a see a visual indication of the Voice Speaker A's 301c emotion.

However, the emotional mood may be used for other purposes. For example, the emotional mood may be used to select additional content 302 to be provided to one or more of the participants. The voice model selection rules 502 may indicate that if the emotional mood becomes sad, then at a next advertisement break in the sporting event, a happier advertisement (e.g., an advertisement for a vacation or theme park) may be selected to help cheer the group up. There may be a variety of different available content items 302, such as different advertisements, each provided with metadata indicating one or more appropriate moods for usage. Some content may indicate it is unsuitable to be used when the mood is angry. Some content may indicate a desired mood for usage.

The emotional mood may be used to control other actions. For example, the emotional mood may be reported to other service providers, who may use the emotional mood to determine further actions. A bill collector may choose to avoid calling a person if the current emotional mood of that person indicates they are frustrated or angry. The participants may choose to permit to have their emotional mood information sent to other service providers for this purpose.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

We claim:

1. A method comprising:
receiving, by a computing device, a video comprising a participant of a plurality of participants in a video meeting;
receiving information indicating a plurality of different voice models for translating hand signs into voice output;
selecting, based on context information associated with the video meeting, a voice model from the plurality of different voice models; and
generating, based on the selected voice model, voice output corresponding to hand signs made by the participant and detected in the video.

2. The method of claim 1, wherein the selecting based on context information comprises selecting the voice model based on facial expressions of one or more other participants in the video meeting.

3. The method of claim 1, wherein the selecting based on context information comprises selecting the voice model based on voices of one or more other participants in the video meeting.

4. The method of claim 1, wherein the selecting based on context information comprises selecting the voice model based on a second video image, from a different camera, of the participant.

5. The method of claim 1, wherein the selecting based on context information comprises selecting the voice model based on content metadata indicating events occurring in a video stream that is being viewed by the plurality of participants in the video meeting.

6. The method of claim 1, wherein the selecting based on context information comprises:
determining a meeting mood level by combining mood information for the plurality of participants; and
selecting the voice model based on the meeting mood level.

7. The method of claim 1, further comprising selecting different voice models to annunciate different words in a sequence of hand signs.

8. The method of claim 1, wherein the selecting based on context information comprises selecting the voice model based on one or more of:
a facial expression of the participant;
a facial expression of another participant of the plurality of participants;
a reaction of another user who is not among the plurality of participants;
information indicating an excitement level of a portion of a video stream being viewed by the plurality of participants;
information indicating an event occurring in a video stream being viewed by the plurality of participants.

9. The method of claim 1, wherein the different voice models comprise different audio annunciations of a first hand sign.

10. The method of claim 1, further comprising adding, based on the context information and a detected hand sign in the video, an audio or video embellishment to the video meeting.

11. The method of claim 1, wherein the selecting is based on voice model selection rules indicating, for a hand sign, one or more rules for selecting between different voice models for annunciating the hand sign.

12. A method comprising:
storing a plurality of different voice models for annunciating a particular sign language sign;
storing one or more voice model selection rules indicating different contexts in which the different voice models should be selected for annunciating the particular sign language sign;
based on recognizing that a signer has made the particular sign language sign, using the one or more voice model selection rules to select one of the voice models; and
using the selected voice model to audibly annunciate the particular sign language sign.

13. The method of claim 12, wherein the rules comprise rules for selecting the selected voice model based on content metadata indicating events occurring in a content item being viewed by the signer.

14. The method of claim 12, wherein the rules comprise rules for selecting the selected voice model based on environmental conditions of an environment the signer.

15. The method of claim 12, wherein the rules comprise rules for selecting the selected voice model based on context information of other users participating in a video session with the signer.

16. The method of claim 12, further comprising using different voice models to annunciate different words in a sequence of signs, wherein the different voice models comprise different audio annunciations of a same word.

17. A method comprising:
receiving video;
detecting, in the video, a sequence of hand signs; and
using different audio voice models to annunciate different signs in the sequence of hand signs, wherein the different audio voice models each comprise a different audio annunciation for a same hand sign.

18. The method of claim 17, further comprising:
selecting the different audio voice models based on different facial expressions of a signer making the hand signs.

19. The method of claim 17, further comprising:
monitoring environmental conditions, associated with the audio, during the sequence of hand signs; and
selecting the different audio voice models based on different environmental conditions associated with the video.

20. The method of claim 17, further comprising translating the sequence of hand signs to a textual transcript.
